(19) United States
(12) Patent Application Publication
(10) Pub. No.: US 2014/0332540 A1
(43) Pub. Date: Nov. 13, 2014

(54) ROTATIONAL MOULDING METHOD

(71) Applicant: Blue Wave Co S.A., Luxembourg (LU)

(72) Inventors: Francesco Nettis, London (GB); Giuseppe Bergamin, Montanaro (IT); Giulio Carini, Luxembourg (LU); Daniele D'Amelj, Torgiano (IT); Gianfranco Niso, Luxembourg (LU); Paolo Redondi, Gorle (IT); Amedeo Silvagni, London (GB); Vanni Neri Tomaselli, Luxembourg (LU)

(21) Appl. No.: 14/363,154

(22) PCT Filed: Dec. 5, 2012
(86) PCT No.: PCT/EP2012/074560

§ 371 Date: Jun. 5, 2014

(30) Foreign Application Priority Data
Dec. 5, 2011 (WO) PCTEP2011071789
Dec. 5, 2011 (WO) PCTEP2011071793
Dec. 5, 2011 (WO) PCTEP2011071805

(51) Int. Cl. F17C 1/02; B29C 41/46; B29C 41/04

(52) U.S. Cl. CPC F17C 1/02; B29C 41/042; B29C 41/46; F17C 2203/0604; F17C 2203/0629; F17C 2203/066; F17C 2209/2145; B29K 2101/10
USPC 220/586; 264/311; 425/425

(57) ABSTRACT

The present invention relates to a method of rotational moulding where a heating structure is incorporated into the mould. Further aspects of the invention relate to a mould for rotational moulding comprising a heating element. In an embodiment, the mould is a pressure vessel for transporting and storing compressed natural gas. The heating element may be incorporated into the pressure vessel, or may be placed in contact with the pressure vessel for the duration of the rotational moulding process.

The present invention claims priority from PCT/EP2011/071789, “Type-4 Tank for CNG Containment”, PCT/EP2011/071805, “Multilayer Pressure Vessel” and PCT/EP2011/071793, “Inspectable Containers for the Transport by Sea of Compressed Natural Gas, Fitted with a Manhole for Internal Access”, the entire contents of each of which are incorporated herein in full by way of reference. The features of the pressure vessels disclosed in those prior filings are relevant and compatible with the present invention.

### FIELD OF THE INVENTION

The present invention relates to a method of preparing moulded objects by means of a process of rotational moulding. More particularly it relates to the use of such methods using heated material, and the preparation of vessels so that they are suitable for containing or transporting compressed natural gas (CNG) using such methods.

### BACKGROUND ART

The process of rotational moulding or rotomoulding involves preparing a hollow mould and introducing a settable material into that mould. The settable material is capable of flowing and the mould is rotated so that the settable material flows inside the mould, eventually providing a layer which lines the inner surface of the mould. The settable material then sets and the mould is removed, providing an object conforming to the shape of the mould. In certain processes, the mould is retained as part of the resulting structure.

Polymers may provide the settable material, but such materials do have to be heated, either to allow them to flow or to set, or both. The disadvantage here is that heating of the material over the entire mould is required to ensure consistent behaviour of the material throughout the mould. This is less of a concern when the mould is relatively small. In such cases the rotational apparatus which rotates the mould may be housed in an oven or similar heating equipment, which will then heat not only the mould, but portions of the rotational equipment too.

However, when the mould is larger, the heating of the mould and the rotational equipment becomes particularly inefficient. Furthermore, the greater the extent of movement of the mould, the greater the space which will need to be heated in such an arrangement. Therefore, such known arrangements result in significant inefficiencies, particularly when the mould is large.

In addition, the greater the ratio between length and diameter of the moulded object, the greater is the potential need or desire for accuracy for the control of temperature of the mould during the process.

A particular application of rotational moulding to large moulds involves the manufacture and preparation of pressure vessels, particularly those used for the storage and transport of pressurised gas such as compressed natural gas (CNG).

The manufacture and preparation of pressure vessels with the use of rotational moulding forms the subject of a patent application to the current Applicant, filed on the same date as this application, with the title “Polymeric Coated CNG Tank and Method of Preparation”. The entire contents of this application are incorporated herein in full by way of reference.

### Technical Problem to be Solved

The present invention aims to overcome or alleviate at least one of the disadvantages of known methods of rotational moulding.

In particular, an object of the present invention is to provide a more energy efficient method of rotational moulding.

It is a further object of the present invention to provide for moulds for use with a method of rotational moulding.

It is a further object of the present invention to provide for a method of manufacturing corrosion resistant coating/layer(s) for pressurised vessels, which are suitable for transporting CNG gas by means of rotational moulding.

### SUMMARY OF THE INVENTION

According to the present invention there is provided a method of rotational moulding, the method comprising:
providing a mould assembly, including a mould and a heating element;
placing a polymer within the mould;
heating the mould by activating the heating element to thereby heat the polymer; and
moving the mould so as to line an inner surface of the mould with a layer of the polymer, the polymer thereby forming a lining for the mould.

Preferably the heating element is arranged, in use, to be in contact with the mould.

A further aspect of the invention extends to a method of rotational moulding, the method comprising:
providing a mould incorporating a heating element in contact with the mould;
placing a polymer within the mould;
heating the mould by activating the heating element to thereby heat the polymer; and
moving the mould so as to line an inner surface of the mould with a layer of the polymer, the polymer thereby forming a lining for the mould.

The heating element may be incorporated into or onto the mould. Preferably the heating element is in contact with the mould by being incorporated into the mould.

In certain embodiments, the heating element forms part of the walls of the mould where the walls define a hollow which is lined during the process of rotational moulding.

The heating element may be placed in contact with a surface of the mould, for example at least during the heating of the mould.

In some embodiments the heating element may be placed in contact with an outer and/or an inner surface of the mould.

The heating element may be elongate or it may comprise elongate members in which case it is preferred that a substantial portion of the elongate heating element or the elongate members are placed in contact with a surface of the mould.

In an embodiment, the elongate heating element is placed in contact over a majority of its length. Similarly, in a further embodiment, the elongate members are placed in contact with the mould over a majority of their cumulative length.

The heating element may comprise an electrical conductor. In further embodiments, the heating element may comprise a conduit for a heated fluid. The fluid may be, for example, water or oil.

Movement of the mould may comprise rotation of the mould by a rotation apparatus.

The rotation apparatus may comprise the heating element so that when the mould is mounted in the rotation apparatus the heating element is placed in contact with the mould.

The polymer may be substantially corrosion resistant with respect to the fuel or fluid to be stored and/or transported by a pressure vessel incorporating a mould used with embodiments of the invention. Preferably the polymer is substantially inert relative to, i.e. it will tend not to corrode when in contact with, the fuel or fluid to be stored or transported. To be deemed substantially inert relative to the fuel or fluid to be stored or transported, the polymer may have corrosion resistance properties relative to the fuel or fluid to be stored or transported of at least an AISI 316 stainless steel. For example, this degree of corrosion resistance may be determined relative to one or more of the anticipated contaminates therein, one such contaminate being the expected level of typically aggressive compounds such as H₂S, e.g. in the presence of H₂O. Another mode of determining whether the material is deemed to be substantially inert relative to the fuel or fluid to be stored or transported is to determine whether the material, or internal wall, is essentially H₂S resistant, i.e. substantially H₂S resistant, or preferably H₂S resistant. One approach for determining this is to determine whether the material behaviour is equivalent to a metal alloy in accordance with ISO15156.

It is to be realized however that the characteristics of the polymer may change as it progresses through various stages of the manufacturing process. The corrosion resistance characteristics mentioned above are characteristics determined once the polymer is incorporated into a pressure vessel and is ready for, or is in, use.

In certain embodiments, the polymer is a thermoplastic polymer and in this case, the step of heating the polymer occurs prior to the step of moving the mould. In further embodiments, the polymer is a thermoset polymer and in this case the step of heating the polymer occurs after the step of moving the mould.

A thermoplastic polymer may be selected from the group comprising: high-density polyethylene, poly-propylene and polyvinyl chloride. A thermoset polymer may be selected from the group comprising: an epoxy resin, a polyester resin, a vinyl ester resin and a poly-cyclopentadiene resin.

The mould may be a pressure vessel having a metallic wall wherein the polymer lining adheres to an inner surface of the wall after movement of the pressure vessel. In this case, the lining is likely not to be removed from the mould after the process has finished. However, in other embodiments of rotational moulding, the lining might be removed and the mould might even be reused.

The pressure vessel may be composed of a material, or combination of materials, selected from the group comprising: carbon steel, carbon steel alloys, stainless steel, stainless steel alloys, aluminium, aluminium-based alloys, nickel, nickel-based alloys, titanium or titanium-based alloys.

The pressure vessel used as the mould may have one or more of the following optional characteristics:
it may be of a generally cylindrical shape over a majority of its length;
it may have a length to diameter ration of 10:1 or less; and
it may have an inner diameter of between 1.5 meters and 3.5 meters.

The invention further extends to a method of producing an object by rotational moulding including the steps of providing a mould, heating the mould and rotating the mould by use of a rotational apparatus so that an inner surface of the mould is covered with a polymer and then causing the polymer to set, wherein heating the mould does not cause heating of the rotational apparatus.

The invention further extends to a pressure vessel manufactured according to any one of the methods herein described.

The invention further extend to a method of storing or transporting gas onshore or offshore, in particular compressed natural gas, using at least one pressure vessel as herein described.

The invention further extends to a vehicle for transporting gas, in particular compressed natural gas, comprising at least one vessel constructed by use of a method as herein described.

The invention further extends to a mould for use in rotational moulding comprising a hollow structure composed of a thermally conductive material, the mould having an inner surface and an outer surface wherein, during rotational moulding, a liner of polymer adheres to the inner surface, the mould further comprising or incorporating a heating element.

The heating element may be in contact with the outer surface of the mould.

The heating element may be incorporated into the hollow structure of the mould.

The heating element may be electrically conductive or may comprise or consist of a conduit for a heated fluid.

The invention further extends to apparatus for rotating a mould during a process of rotational moulding comprising a cradle for mounting the mould wherein the cradle is adapted to be moved to thereby move the mould during rotational moulding, the cradle comprising a heating structure to be placed in contact with the mould when the mould is mounted in the cradle, said heating structure heating the mould when mounted in the cradle during rotational moulding.

The mould may be a pressure vessel and the cradle may be adapted to removably accommodate the pressure vessel.

The heating structure may comprise or consist of an electrical conductor or a conduit for a heated fluid.

CNG loading and offloading procedures and facilities depend on several factors linked to the locations of gas sources and the composition of the gas concerned.

With respect to facilities for connecting to ships (buoys, platform, jetty, etc. . . . ) it is desirable to increase flexibility and minimize infrastructure costs. Typically, the selection of which facility to use is made taking the following criteria into consideration:
safety;
reliability and regularity;
bathymetric characteristics water depth and movement characteristics; and
ship operation: proximity and manoeuvring.

A typical platform comprises an infrastructure for collecting the gas which is connected with the seabed.

A jetty is another typical solution for connecting to ships (loading or offloading) which finds application when the gas source is onshore. From a treatment plant, where gas is treated and compressed to suitable loading pressure as CNG, a gas pipeline extends to the jetty and is used for loading and offloading operations. A mechanical arm extends from the jetty to a ship.

Jetties are a relatively well-established solution. However, building a new jetty is expensive and time-intensive. Jetties also require a significant amount of space and have a relatively high environmental impact, specifically in protected areas and for marine traffic.

Solutions utilizing buoys can be categorized as follows:
CALM buoy;
STL system;
SLS system; and
SAL system.

The Catenary Anchor Leg Mooring (CALM) buoy is particularly suitable for shallow water. The system is based on having the ship moor to a buoy floating on the surface of the water. The main components of the system are: a buoy with an integrated turret, a swivel, piping, utilities, one or more hoses, hawsers for connecting to the ship, a mooring system including chains and anchors connecting to the seabed. The system also comprises a flexible riser connected to the seabed. This type of buoy requires the support of an auxiliary/service vessel for connecting the hawser and piping to the ship.

The Submerged Turret Loading System (STL) comprises a connection and disconnection device for rough sea conditions. The system is based on a floating buoy moored to the seabed (the buoy will float in an equilibrium position below the sea surface ready for the connection). When connecting to a ship, the buoy is pulled up and secured to a mating cone inside the ship. The connection allows free rotation of the ship hull around the buoy turret. The system also comprises a flexible riser connected to the seabed, but requires dedicated spaces inside the ship to allow the connection.

The Submerged Loading System (SLS) consists of a seabed mounted swivel system connected to a loading/offloading riser and acoustic transponders. The connection of the floating hose can be performed easily without a support vessel. By means of a pick up rope the flexible riser can be lifted and then connected to a corresponding connector on the ship.

The Single Anchor Loading (SAL) comprises a mooring and a fluid swivel with a single mooring line, a flexible riser for fluid transfer and a single anchor for anchoring to the seabed. A tanker is connected to the system by pulling the mooring line and the riser together from the seabed and up towards the vessel. Then the mooring line is secured and the riser is connected to the vessel.

### Advantages of Embodiments of the Invention

The method according to the present invention may allow reduction in the unit cost of production of pressure vessels.

Moreover, the present invention may allow less plastic material to be used for the pressure vessel, whilst maintaining its resistance to corrosion.

### BRIEF DESCRIPTION OF THE DRAWINGS

FIG. 1 is a process diagram illustrating a method of preparing a pressure vessel of an embodiment of the invention;

FIG. 2 is a process diagram illustrating a method of preparing a pressure vessel of a further embodiment of the invention;

FIG. 3 is a schematic diagram of a rotational moulding machine for operating a method according to an embodiment of the invention;

FIG. 4 is a plan view of the rotomoulding machine of FIG. 3;

FIG. 5 is a schematic illustration of a cradle for heating a pressure vessel for use with the rotomoulding machine of FIG. 4, the cradle being in an open configuration;

FIG. 6 is a schematic illustration of the cradle of FIG. 5 instead in a closed state around a pressure vessel, installed in an electrical circuit;

FIGS. 7 and 8 are schematic illustrations of a metal pressure vessel in cross section;

FIGS. 9 and 10 are schematic illustrations of a pressure vessel, which has undergone a preparation process, in cross section; and

FIGS. 11 and 12 are schematic illustrations of arrangements of heating elements incorporated into pressure vessels.

### DETAILED DESCRIPTION OF THE INVENTION

Embodiments of the invention extend to a process of rotational moulding where a mould is lined with a polymer through a process of moving the mould, for example by means of rotation. Heating of the mould is required either to allow the polymer to flow or to allow it to set once it has flowed into the required shape.

Certain embodiments of the invention are particularly applicable to the preparation of pressure vessels to render them suitable, or more suitable, for either or both the transportation or storage of CNG through a process of rotational moulding or rotomoulding, e.g. for allowing transportation or storage for longer periods of time. In such embodiments, the pressure vessel may act as a mould, in which case the moulded object forms a lining for the pressure vessel and is not removed once the process is completed.

For example, a pre-existing pressure vessel (one or more examples of which is described in greater detail below), which acts as a hollow mould, is filled with a charge or shot weight of polymer. It is then slowly rotated (usually around two axes perpendicular with respect to each other) thus causing the material to disperse and to stick to the walls of the mould. It is possible to use either thermoplastic polymers or thermoset polymers.

Embodiments of the invention are described with reference to the manufacture and preparation of pressure vessels. However, it is to be understood that the invention is not so limited; finding application to the manufacture, preparation and repair of many other objects.

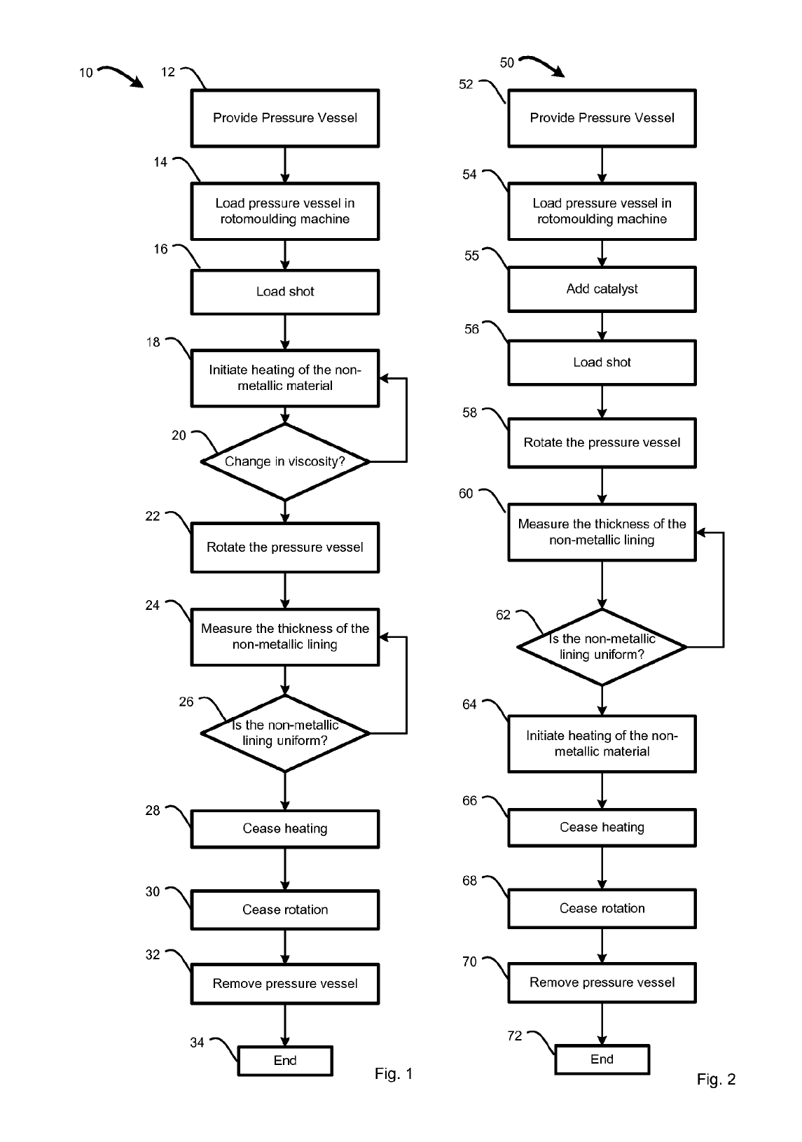

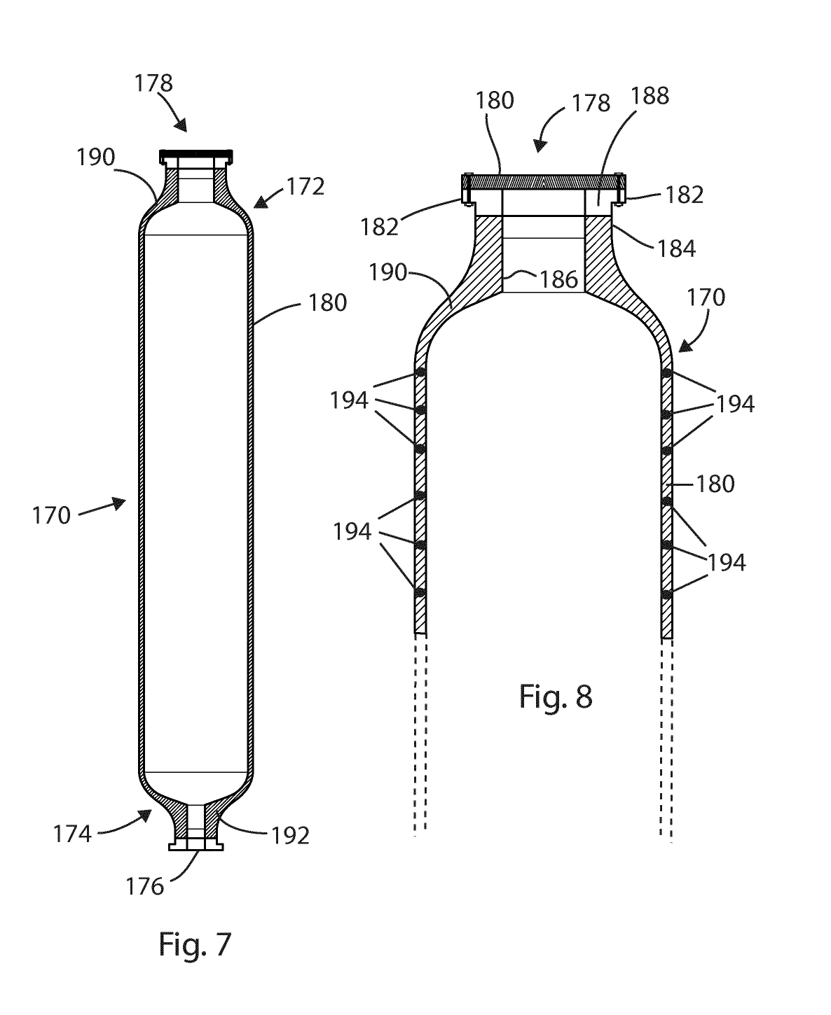

FIG. 1 illustrates a process diagram of a method 10 according to a first embodiment of the invention where use is made of thermoplastic polymers. At an initial step 12, a pressure vessel is provided. In embodiments of the invention, the pressure vessel which is provided is a pre-existing cylindrical pressure vessel having a metal outer wall. Such pressure vessels are described in greater detail below with reference to FIGS. 7 to 10. Advantageously, embodiments of the invention are able to take existing pressure vessels and render them safe for CNG storage and transport in a cost-effective manner. In particular, by use of a rotomoulding process, existing pressure vessels can be adapted to the storage and transport of CNG.

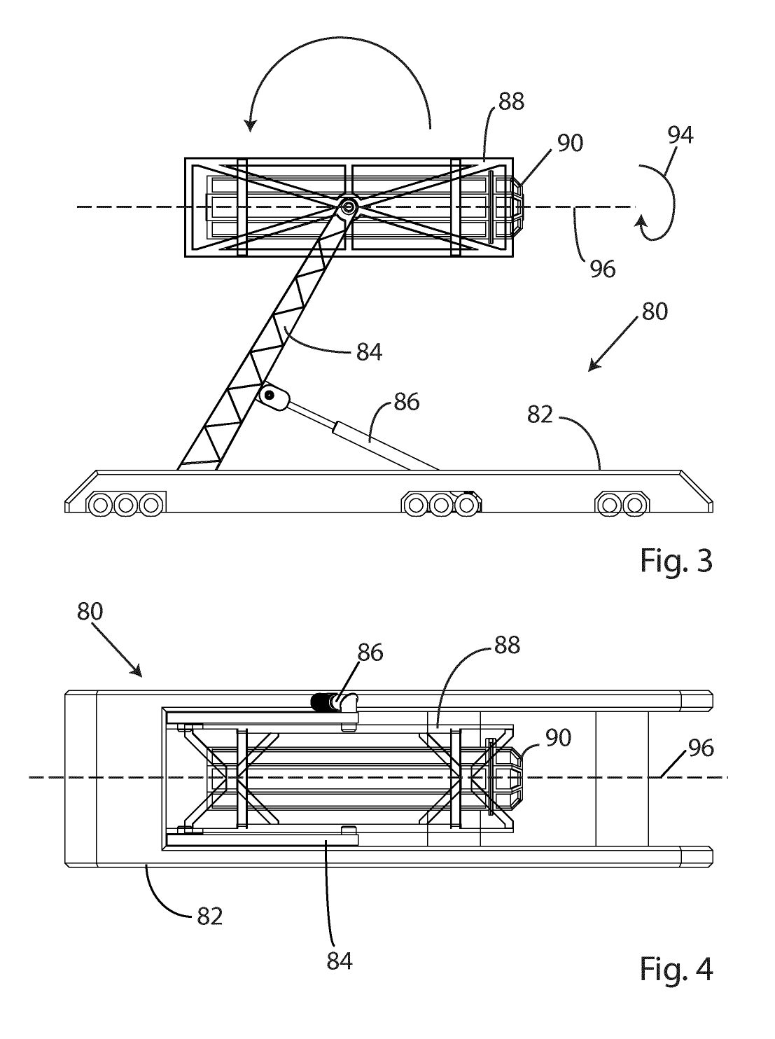

At the following step, step 14, the pressure vessel is loaded into the rotomoulding machine, an example of which is shown in greater detail in FIGS. 3 to 6, for example in a manner described in greater detail below with reference to those Figures.

In step 16, a shot of the polymer, in this embodiment comprising a predetermined amount of a thermoplastic polymer, is inserted into the pressure vessel through an opening provided in the pressure vessel.

Different embodiments involve the use of different thermoplastic polymers. For example, any one of: high-density polyethylene, poly-propylene or polyvinyl chloride may be used, depending on the intended use and cost of the pressure vessel, and other production considerations.

Heating of the shot is initiated at step 18. In this embodiment, the shot of polymer is heated by heating the pressure vessel. The temperature level, and the temperature ramp, to which the pressure vessel is heated will depend on the composition of the polymer used and on the thermal properties of the vessel's structural material. Furthermore, the vessel is heated until the viscosity of the polymer has altered sufficiently to allow the polymer to flow evenly, as determined in step 20. If the viscosity has changed sufficiently, the process will proceed to step 22. If additional heating is required, the process will loop between steps 20 and 18 until the viscosity has changed sufficiently for it to flow in the pressure vessel.

In embodiments of the invention, the pressure vessel includes a sensor for determining or approximating the viscosity of the polymer during heating. The simplest arrangement of such a sensor comprises an observation port, e.g. at an end of the vessel, through which an observer may view the behaviour of the shot of polymer during movement of the pressure vessel. In further embodiments, other known sensors for measuring or approximating the viscosity are used, for example cameras or empirical data providers such as temperature sensors.

In an alternate embodiment of the invention, the pressure vessel is heated at step 18 for a predetermined time, depending on the composition of the pressure vessel and the composition of the polymer. The manner in which this heating occurs is described in greater detail below.

At step 22, the pressure vessel is rotated. Rotation of the pressure vessel causes the thermoplastic polymer to flow over the inner surface of the pressure vessel and thereby line the inner surface with a lining of the thermoplastic polymer. In this manner, the pressure vessel forms a mould for the lining of the polymer, because the shape of the inner surface of the mould is imparted to the polymer.

It is to be realised that the most efficient manner for rotating the pressure vessel to ensure a uniform thickness for the lining for the polymer will depend on a number of factors such as the shape of the pressure vessel and the viscosity of the polymer during rotation. In one embodiment, the pressure vessel is rotated only about its longitudinal axis. In a further embodiment, the pressure vessel is additionally rotated in at least one additional direction, such as one or more direction lying perpendicular to its longitudinal axis.

In step 24 the thickness of the lining is measured to ensure that the desired parts of the lining or pressure vessel, or all parts of the lining or pressure vessel, have a uniform or desired thickness, or meet predetermined thickness ranges, such as between 5 and 50 mm. Therefore, a decision is made in the following step, step 26, whether the lining is suitably uniform or not on the basis of the measurements made in step 24. If it is determined at step 26 that the lining is not suitably uniform, or fails to meet alternative criteria as to thickness, the process will return to step 24 to make a further measurement once the pressure vessel has undergone further rotation.

The thickness and distribution of the lining might be determined by physical inspection at one end of the pressure vessel, e.g. by x-ray/tomography, by ultrasonic testing or in other known manners.

Once it is determined at step 26 that the lining is suitably uniform, or within appropriate thickness tolerances, the process will proceed to step 28 where heating of the polymer is ceased. This allows the polymer to set. Advantageously in this embodiment, the rotation continues during the setting process to encourage the lining to maintain a uniform thickness, etc. In a further embodiment, the cessation of heating may be accompanied by active cooling to reduce the overall time of the process.

Once the thermoplastic polymer has set, the process proceeds to step 30 where rotation is stopped. In the embodiment illustrated, rotation is stopped after a predetermined time. In a further embodiment, a sensor determines the state of the polymer to determine when it has set and rotation is stopped once the thermoplastic polymer has set to a sufficient extent.

At the following step, step 32, the pressure vessel is removed from the rotomoulding machine. In certain embodiments, additional finishing steps such as cleaning are then carried out on the pressure vessel. The procedure then ends at step 34.

FIG. 2 illustrates a further embodiment where thermoset polymers are used in place of the thermoplastic polymers of the embodiment illustrated in FIG. 1. In many respects, the process of FIG. 2 is similar to that of FIG. 1. When the process is initiated, a pressure vessel is provided in step 52; the vessel is loaded into the rotomoulding machine (step 54); and the shot, which in this case is comprised of a thermoset polymer, is loaded into the pressure vessel. Steps 52, 54 and 56 are similar to steps 12, 14 and 16 of the process of FIG. 1 other than the use of a thermoset polymer in place of a thermoplastic polymer. It is to be realised that any appropriate thermoset polymer may be used. In particular, an epoxy resin, a polyester resin, a vinyl ester resin or a poly-cyclopentadiene resin may be used.

To encourage the curing process of the thermoset polymer, a catalyst can be added to the shot, in this example at step 55.

The thermoset polymer shot is introduced into the pressure vessel in a liquid state in this embodiment. Therefore, in step 58, the vessel is rotated and this rotation causes the thermoset polymer to spread over and adhere to the inner surface of the vessel which therefore acts as a mould for the polymer, in the manner described above with reference to FIG. 1.

Depending on the resin system formulation—the thermosetting base polymer or mix of polymers, or the effect of the catalyst—heat might be needed to start, complete or assist with the “curing” reaction, i.e. the polymerization that turns the material into its solid state. An example where heat is almost certainly needed is with epoxy resin systems. Thus, while the vessel is rotated, the thickness and uniformity of the lining formed are measured or approximated at step 60. Then, once it is determined, at step 62, that the lining is sufficiently uniform and/or the desired thickness has been attained, the pressure vessel is heated at step 64. Heating of the thermoset polymer causes the polymer to set. In this embodiment, the vessel is heated at step 64 for a predetermined time period, and then ceased at step 66. The manner in which this heating occurs is described in greater detail below.

In a further embodiment, the properties of the polymer are measured with an appropriate sensor and heating is ceased once it is determined that the polymer has set sufficiently. The cessation of heating may be accompanied by refrigeration.

Once heating has ceased, rotation of the vessel ceases at step 68 and the vessel is removed from the rotomoulding machine at step 70. The process according to this embodiment ends at step 72.

In order to maintain a suitably even thickness throughout the liner, it is preferred that the mould continues to rotate at all times during the heating phase, and to avoid sagging or deformation, also during the cooling phase.

It is to be appreciated that rotating in only one axis could be enough, especially for the embodiment of FIG. 2 due to the lower viscosity of thermoset compounds. Bi- or multi-axis rotation is nevertheless preferred.

In order to maintain an even thickness throughout the liner, the mould will typically continue to rotate at all times during the hardening phase (e.g. through the reactions with the catalysts). This can also help to avoid sagging or deformation.

Optionally, any of the processes described above may include a final step of depositing a metallic coating, especially if the non-metallic liner was composed of pDCPD (polydicyclopentadiene). A suitable process of depositing such a coating is described in co-pending application PCT/EP2011/071811 entitled Construct Comprising Metalized Dicyclopentadiene Polymer and Method for Producing Same, the entire contents of which are incorporated herein by way of reference.

FIGS. 3 to 12 illustrate various configurations for apparatus for use with methods according to embodiments of the invention.

FIG. 3 is a side view of a preferred rotomoulding machine 80. The machine comprises a base 82 to which a supporting arm 84 is connected. The supporting arm 84 pivots relative to the base 82 and the extent of the pivot is controlled by hydraulic piston 86. At the end of the supporting arm 84 distal to the base 82, a rotating cage 88 is connected.

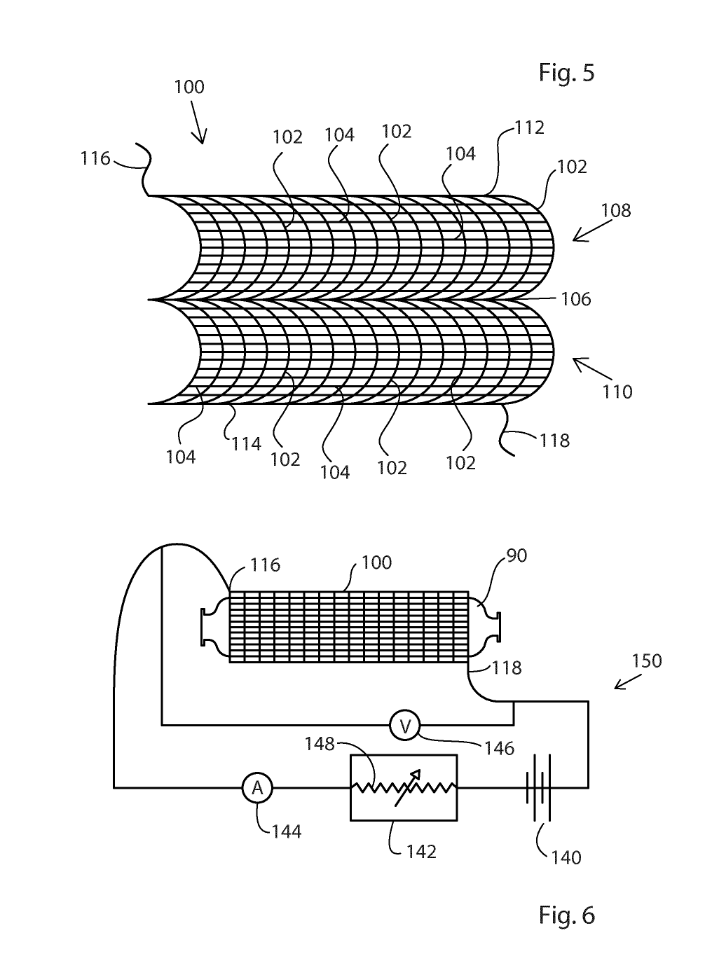

An inner surface of the cage 88 can be provided with a heating cradle (for an example, see FIG. 5).

A pressure vessel 90 of the type to which the process of FIGS. 1 and 2 may be applied is removably mounted in the cage 88. In the preferred arrangement this will be such that an outer surface of the pressure vessel 90 is placed in contact with a heating element such as the heating cradle.

The pressure vessel 90 has a longitudinal axis 96 and the cage 88 is arranged to rotate the pressure vessel about the longitudinal axis 96 in the direction of arrow 94. Furthermore, cage 88 is arranged relative to the supporting arm 84, to rotate in the direction of arrow 92, thereby rotating pressure vessel 90 in this direction too. It is to be realised that in further embodiments, the pressure vessel 90 may rotate in other directions instead of, or in addition to, the directions illustrated in FIG. 3.

FIG. 4 is a top or plan view of the rotomoulding machine 80 of FIG. 3.

As described above, regardless of whether a thermoplastic polymer (FIG. 1) or a thermoset polymer (FIG. 2) is used, a step of heating the mould is involved. In preferred embodiments of this invention, the heating of the mould is accomplished by heating a heating element which is placed in contact with the mould. This increases the efficiency of the transfer of heat to the mould. This, in turn, results in a more constant and accurate temperature control of the polymeric material and of the rotational moulding process, in general. The heating element might alternatively be an integral part of the mould.

FIG. 5 illustrates a cradle 100 for a pressure vessel which acts as a mould in the manner described above with reference to FIGS. 1 to 4. The cradle 100 is comprised of a mesh formed by a plurality of wires 102 laid parallel to one another with a plurality of intersecting wires 104 also laid parallel to one another, but substantially normal to the wires 102. The wires 102 are attached to the intersecting wires 104 where they come into contact. Other orientations or layouts are also useable.

In this illustrated embodiment the mesh is formed as two halves 108 and 110 which pivot relative to one about a hinge 106 which runs longitudinally along the cradle 100. Alternatively, there may be more than two parts, each arranged to pivot relative to its neighbour, or otherwise arranged to be joined together around the mould.

In other embodiments, the mesh may even be a flexible wrap that can be wrapped around the mould.

Each of the wires 102 and 104 is preferably an electrical conductor with a relatively high resistance so that when an electrical current is passed therethrough, heat is generated.

The wires 102 and 104 are preferably all electrically connected to one another along the edges 112 and 114 of the cradle 100 so that they form a single electrical circuit.

In this preferred embodiment the cradle further comprises two electrical terminals 116 and 118. As shown they can be arranged on respective edges 112 and 114 of the cradle 100 and at opposing distal ends of the cradle. When the cradle is installed, the electrical terminals 116 and 118 will then be in proximity to the longitudinal axis of the mould. This facilitates connection of the cradle as problems imposed by rotation are removed or minimized in the area close to the longitudinal axis of the mould.

In a further embodiment, the cradle extends over the ends of the pressure vessel.

In an embodiment, the electrical terminals are located close to an axis of rotation, at least with reference to the size of the mould as measured from an axis of rotation. By locating the terminals where there is no or relatively little rotational movement, the connection of the terminals is facilitated.

In use, the cradle 100 is installed in the inner surface of the rotating cage 88 of the rotomoulding machine 80 illustrated in FIG. 3 and described above. When installed in the rotating cage 88, the terminals 116 and 118 of the cradle 100 are connected to an electrical circuit.

FIG. 6 schematically illustrates the pressure vessel 90 installed in the rotating cage 88 of the rotomoulding machine 80 of FIG. 3. Only the cradle 100 of the rotomoulding machine 80 is shown in this Figure. Furthermore, for the sake of illustration, a space is illustrated between the cradle 100 and the pressure vessel 90. However, in practice, all, or most of, the cradle will be in contact with the pressure vessel 90.

The terminal 116 is connected to an electrical circuit 150, which is also connected to the terminal 118. The electrical circuit 150 further comprises a source of electrical power, which in this embodiment is a cell 140 which acts as an electrical supply to the circuit, here in the form of Direct Current (DC), although Alternating Current (AC) could be used in an alternate embodiment.

The electrical circuit, as illustrated, further comprises a control 142, an ammeter 144 and a voltmeter 146. The ammeter 144 and voltmeter 146 are typically provided to provide information regarding the electrical circuit to a user or controller. The control 142 includes a variable resistor 148 which can be used by a user or controller to control the current delivered to the cradle 100.

As previously mentioned, the wires which comprise the cradle 100 have an electrical resistance which is such that when a current is passed therethrough, heat is generated. The manner in which this is done will depend on the dimensions of the cradle, as well as the amount of heat which it is desired to produce.

The control 142 can comprise a user operated panel and the variable resistor 148 which a user can use to control the behaviour of the electrical circuit and thereby the heating and cooling of the pressure vessel 90.

Temperature can be also measured, displayed to the user and controlled by the user (the corresponding elements to allow this are not shown, but are well known to those skilled in relevant arts).

In this embodiment, the control 142 comprises the variable resistor 148, which the user uses to control the overall resistance of the circuit and therefore the current flowing through the cradle 100, which will control the temperature of the cradle. It is to be realised that the control 142 may, in certain embodiments, show the user the outputs of the various sensors described above with reference to the process of FIGS. 1 and 2.

The heating element can be placed in contact with the pressure vessel or other mould either by having the heating element in contact with an outer surface of the mould (i.e. the pressure vessel in the process described above) or by incorporating the heating element into the mould itself.

With the illustrated embodiment, it is to be realised that direct contact between the heating element and the mould is not necessary along the entire length of the heating element, provided that heat can be transferred efficiently between the heating element and the mould. Furthermore, since the heating element moves in relation to the mould as the mould is inserted, rotated and removed, the degree of contact between the heating element and the mould will vary. Therefore, where the heating element is elongate, or it includes elongate members, it is sufficient that a substantial portion of the elongate heating element or members of the elongate heating element are in contact with the mould.

The use of a cradle such as that illustrated in FIG. 5, or other arrangements where the heating element is brought into contact with the pressure vessel are particularly well suited to repurposing pressure vessels for the transport and/or storage of CNG as the cradle (for example) can be prepared and dimensioned to fit the existing vessel.

In relation to the repurposing of pressure vessels, in addition to those already mentioned cases, other suitable vessels for use with the present invention, are disclosed in PCT/EP2011/071797, PCT/EP2011/071794, PCT/EP2011/071798, PCT/EP2011/071786, PCT/EP2011/071810, PCT/EP2011/071809, PCT/EP2011/071808, PCT/EP2011/071815, PCT/EP2011/071813, PCT/EP2011/071812, PCT/EP2011/071807, PCT/EP2011/071801, PCT/EP2011/071817, and PCT/EP2011/071791. The entire contents of these additional cases are incorporated herein by way of reference, along with the other already mentioned cases.

In the embodiments illustrated, the heating element has been brought into contact with an outer surface of the mould (e.g. the pressure vessel). In alternate embodiments, the heating element may be brought into contact with an inner surface of the mould. This suffers from the disadvantage that the heating element will be covered during the rotational moulding process, but has the advantage that less power is needed to heat the polymer as it does not need to dissipate through the material of the mould walls.

In an alternative arrangement, the heating element is incorporated into the mould itself. Again using the example where the pressure vessel constitutes the mould and to which the methods of FIGS. 1 and 2 would apply, a heating element may, instead of being provided in contact with an outer surface of the mould such as cradle 100 of FIGS. 5 and 6, be incorporated into the wall, typically the outer wall, of the pressure vessel. FIGS. 7 and 8 illustrate an example of a pressure vessel 170 according to such an alternate arrangement. Other arrangements are also possible.

In this illustrated example, the vessel 170 has a top end 172 and a bottom end 174. The bottom end has a loading/offloading opening 176, typically for connecting to pipework (not shown). In this preferred arrangement, the loading/offloading opening is a 12 inch (30 cm) opening. Further, the top end has a manhole 178, e.g. to allow operator access to the inside of the pressure vessel.

The vessel 170 further comprises a steel cylindrical body 180, and steel ends 172, 174.

In this embodiment, either the manhole 178 or the loading/offloading opening 176 may be used to introduce the shot of polymer during the methods of preparing a pressure vessel described above with reference to FIGS. 1 and 2.

Referring to FIG. 8, a manhole cover 180 is arranged to close the manhole 178 and in this example, it is arranged to be bolted down over a flanged end of the manhole 178—the bolts extend through outwardly extended flanges 182 on the free end of the neck 184 of the vessel 170. The manhole or the loading/offloading opening can be used for placing the polymer in the vessel 170 prior to heating and rotation. The manhole may be used for inspection after the rotomoulding process to ensure that the polymer lining has been evenly distributed and that the lining has set. A suitable arrangement for the manhole is disclosed and discussed in co-pending application PCT/EP2011/071793, from which priority is claimed, and from which the entire contents are incorporated herein by way of reference.

In the embodiment of FIGS. 7 and 8, the neck 184 features an internal wall 186 that defines the opening-size of the manhole. That internal wall 186, as shown, is vertically arranged in preferred uses of the vessel, e.g. when fitted in a ship, although it may be rotating during most rotomolding processes.

The manhole's flanged end-cap 188 is shown here to be formed separate to the necked portion of the main body of the vessel 170, and it is here welded onto an end wall of that necked portion. It is possible, however, for the end-cap 188 to be forged onto the necked portion, thus being an integral part of the end 172.

The pressure vessel 170 of FIGS. 7 and 8 is suitable for use with the rotational moulding apparatus 80 illustrated in FIG. 3. Therefore, the pressure vessel 170 may be specifically manufactured for use with the rotational moulding apparatus 80, or vice versa.

In order to facilitate the heating of the pressure vessel 170 during the process of rotational moulding, the vessel 170 includes a heating element. In this embodiment, the heating element comprises an electrical conductor 194 which is embedded in the steel cylindrical body 180 of the vessel 170.

As illustrated in FIG. 8, the electrical conductor 180 may be wound through the steel cylindrical body 180 and terminates in two electrical terminals 190 and 192, only one of which is illustrated in FIG. 8. During use, the terminals 190 and 192 are connected to an electrical circuit such as the circuit 150 illustrated in FIG. 6.

Although pressure vessels of varying shapes and sizes may be used with the processes of embodiments of the invention, it has been found that a pressure vessel being generally cylindrical over a majority of its length has the advantage that rotation about a longitudinal axis of the pressure vessel coats the entire inner surface of the vessel with the polymer during processes of embodiments of the invention. Therefore pressure vessels may be prepared with a non-metallic lining with only rotation about a single axis which is a simpler arrangement than one requiring rotation about more than one axis. Furthermore, it has been found that pressure vessels having a length to diameter ratio of 10:1 or less and where the inner diameter of the vessel (10) is between 1.5 meters and 3.5 meters are particularly suitable to preparation by the processes described herein. Vessels with a greater length, in comparison to their width, are inefficient to heat using known methods.

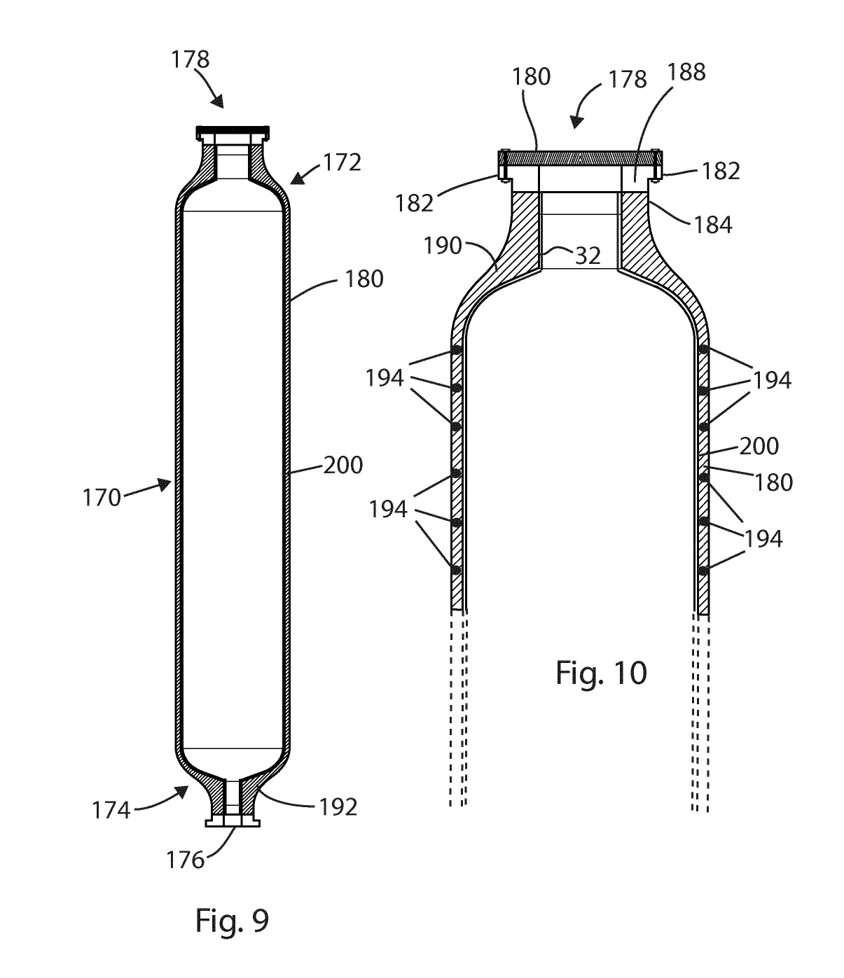

Referring next to FIGS. 9 and 10, the pressure vessel 170 of FIGS. 7 and 8 is shown after undergoing the rotational moulding process illustrated in FIG. 1 or 2. Once the pressure vessel 170 has undergone either of these processes of rotational moulding a non-metallic liner or lining 200 covers or coats an inner surface of the steel cylindrical body 180.

In pressure vessels such as the vessel 170 used with embodiments of the invention, the steel cylindrical body 180 is a metal structural element in that it is made from metal and it supports the structure of the vessel. The heating element such as the electrical conductors 194 are incorporated into this structural element. In alternative embodiments, the heating element is brought into contact with the structural element.

Advantageously, the metallic material has a pre-existing structure which forms the mould to provide the shape to the resulting lining.

In the embodiment illustrated the metal structural element provides an outer shell for the vessel. In further embodiments, the structural element may instead, or in addition, provide an internal structural element for the vessel, e.g. by providing an outer covering.

It is to be realised that the mould, in general, or the pressure vessel or structural element, in particular, may be composed of a material, or combination of materials, selected from the group comprising: carbon steel, carbon steel alloys, stainless steel, stainless steel alloys, aluminium, aluminium-based alloys, nickel, nickel-based alloys, titanium or titanium-based alloys.

Referring again to FIGS. 9 and 10, the internal non-metallic liner 200 is capable of hydraulic containment of raw gases since a suitable thermoplastic or thermoset material is chosen for the liner such that it is non-permeable to the gas because of its micro-structural properties. Natural gas molecules cannot go through the liner because of both spacial arrangement and/or chemical affinity in these materials.

In the embodiment shown, the non-metallic liner 200 is comprised of high-density polyethylene. In an alternative embodiment, the non-metallic liner 200 is comprised of polyvinyl chloride. It is to be realised, however, that any thermoplastic polymer may be used to form the non-metallic liner 200, in particular when the vessel is prepared according to the process of FIG. 1.

In general, the non-metallic liner 200 should be corrosion-proof and capable of carrying non-treated or unprocessed gases, e.g. raw CNG.

When the non-metallic liner 200 is made from thermoplastic polymers it may be preferred to use a polyethylene or similar plastic which is capable of hydrocarbon corrosion resistance.

In an alternative embodiment, e.g. when the vessel is prepared according to the process of FIG. 2, or a similar process, the non-metallic liner 200 is comprised of a thermoset polymer.

In preferred embodiments of the invention, the internal liner 200 has no structural purpose during CNG transportation, loading and offloading phases.

The designs and constructions of vessel described herein may allow a pressure vessel to be made that is, or a pressure vessel that can be adapted to be, able to carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

### FURTHER EMBODIMENTS

Further examples of vessels constructed according to embodiments of the invention are provided below. Any of these, as well as the pressure vessels referred to in the pre-filed applications mentioned above, may be prepared by placing a heating element in contact with an outer surface, or by incorporating such a heating element into a wall of the pressure vessel.

### Example 1

A thermoplastic layer 200 over the metal structure 22 such as high-density polyethylene—HDPE with a density between 0.9 and 1.1 g/cm³, a tensile strength of at least 15 MPa. The thermoplastic layer 2 is produced by multi-axis rotomoulding as explained above.

### Example 2

A thermoset layer 200 over the metal structure 22 such as high-purity poly-cyclopentadiene—pDCPD with a density between 0.9 and 1.1 g/cm³, a tensile strength of at least 45. The thermoset layer 2 is produced by a single-axis rotomoulding machine as explained above.

### Example 3

A thermoset layer 200 over the metal structure 22 such as high-purity poly-cyclopentadiene—pDCPD with a density between 0.9 and 1.1 g/cm³, a tensile strength of at least 45 MPa and a metallic internal coating 1 of the polymeric layer capable of H₂S resistance in accordance with the International Standard (ISO) 15156. The thermoset liner is produced by a single-axis rotomoulding machine to be produced as explained above.

The heating element 194 of the arrangement illustrated in FIGS. 9 and 10 is incorporated into the steel cylindrical body 180 in a spiral formation. It is to be realised, however, that embodiments of the invention are not so limited.

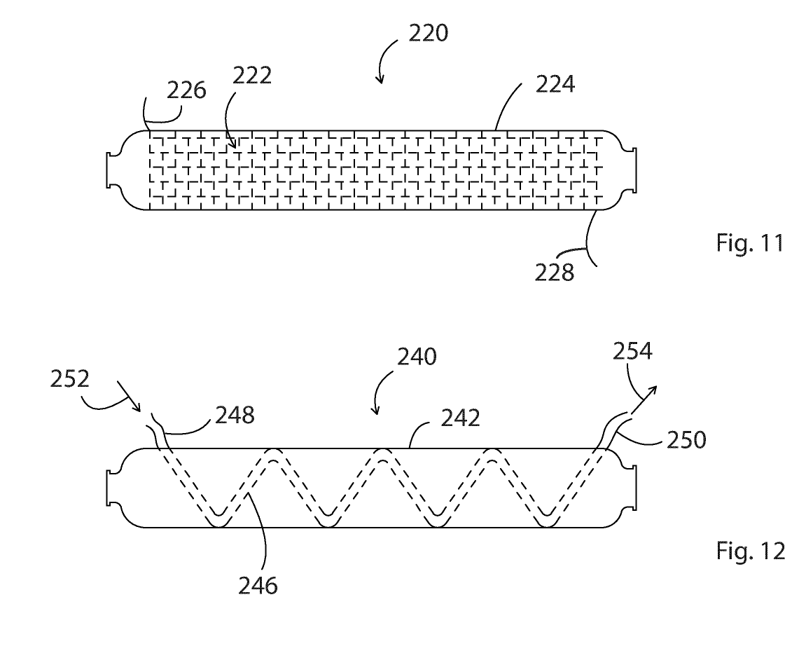

FIGS. 11 and 12 illustrate alternate embodiments where heating elements are in contact with the mould by being incorporated into the cylindrical side walls of pressure vessels.

FIG. 11 illustrates a pressure vessel 220 having a grid-shaped heating element 222 formed from overlaying electrical conductors in a manner similar to the arrangement of the electrical conductors of the cradle 100 illustrated in FIG. 5. In the arrangement of the pressure vessel 220, the electrical conductors of the heating element 222 are incorporated into the steel cylindrical body 224 of the vessel 220. The heating element 222 has two terminals 226 and 228 which are used to pass an electrical current through the heating element 222.

Further arrangements of the heating element are also envisaged. The spacing between adjacent conductors may be altered in accordance with the topology of the mould being heated and/or in accordance with the thermal properties of the used metal and the shape of the obtained mould. In particular, portions of the mould having a larger surface area to volume ratio, which tend to radiate more heat, may be provided with a greater concentration of portions of the heating element.

In the arrangements of heating elements shown, electrical conductors provide the source of heat to the mould (such as the pressure vessel). However, other heating elements may use other sources of heat. FIG. 12 illustrates a mould in the form of a pressure vessel 240 having a steel cylindrical wall 242. A conduit 246 is incorporated into the steel cylindrical wall. The conduit 246 has an inlet 248 and an outlet 250. In use the inlet 248 and the outlet 250 are connected to a heating circuit which uses a fluid such as water or oil to transfer heat from a heat source to the pressure vessel 240.

As illustrated by arrow 252, hot fluid is, in use, introduced into the conduit 246 and exists via the outlet 250, as denoted by arrow 254. In this manner the mould can be heated.

It is to be realised that although a helical arrangement is illustrated for the conduit 246 in FIG. 12, many other arrangements are possible. For example, conduits for heated fluid may alternatively be arranged in parallel conduits or in a grid of such conduits.

No doubt many other effective alternatives will occur to the skilled person. It will be understood that the invention is not limited to the described embodiments and encompasses modifications apparent to those skilled in the art lying within the spirit and scope of the claims appended hereto.

1. A method of rotational moulding, the method comprising:
providing a mould and a heating element in contact with the mould;
placing a polymer within the mould;
heating the mould by activating the heating element to thereby heat the polymer; and
moving the mould so as to line an inner surface of said mould with a layer of said polymer, the polymer thereby forming a lining for said mould.

2. The method according to claim 1 wherein the heating element is incorporated into the mould.

3. The method according to claim 1 wherein the heating element is placed in contact with a surface of the mould, at least during heating of the mould.

4. The method according to claim 3 wherein the heating element is placed in contact with an outer and/or an inner surface of the mould.

5. The method according to claim 3 or claim 4 wherein the heating element comprises one or more elongate members, said method comprising placing a substantial portion of the elongate member in contact with a surface of the mould.

6. The method according to claim 5 wherein the elongate member is placed in contact with a surface of the mould over a majority of a length of the elongate member.

7. The method according to any preceding claim wherein the heating element comprises an electrical conductor.

8. The method according to any of claims 1 to 4 wherein the heating element comprises a conduit for a heated fluid.

9. The method according to any preceding claim wherein movement of the mould comprises a rotation of the mould by a rotation apparatus.

10. The method according to claim 6 wherein the rotation apparatus comprises said heating element so that when said mould is mounted in said rotation apparatus said heating element is placed in contact with said mould.

11. The method according to any preceding claim wherein the polymer has a corrosion resistance of at least that of stainless steel.

12. The method according to any preceding claim wherein the polymer is a thermoplastic polymer and wherein the step of heating the polymer occurs prior to the step of moving the mould.

13. The method according to claim 12 wherein the thermoplastic polymer is selected from the group comprising: high-density polyethylene, poly-propylene and polyvinyl chloride.

14. The method according to any of claims 1 to 12 wherein the polymer is a thermoset polymer.

15. The method of claim 14 wherein thermoset polymer is selected from the group comprising: an epoxy resin, a polyester resin, a vinyl ester resin and a poly-cyclopentadiene resin.

16. The method of claim 14 or claim 15, wherein the step of heating the polymer occurs after the step of moving the mould.

17. The method according to any preceding claim wherein the mould is a pressure vessel having a metallic wall and wherein the polymer lining adheres to an inner surface of said wall after movement of said pressure vessel.

18. The method according to any claim 17 wherein the pressure vessel is composed of a material, or combination of materials, selected from the group comprising: carbon steel, carbon steel alloys, stainless steel, stainless steel alloys, aluminium, aluminium-based alloys, nickel, nickel-based alloys, titanium or titanium-based alloys.

19. A pressure vessel manufactured according to any of claims 1 to 18.

20. A mould for use in rotational moulding comprising a hollow structure composed of a thermally conductive material, said mould having an inner surface and an outer surface wherein, during rotational moulding, a liner of polymer adheres to the inner surface, the mould further comprising a heating element.

21. The mould according to claim 20 wherein the heating element is in contact with the outer surface of the mould.

22. The mould according to claim 20 wherein the heating element is incorporated into the hollow structure.

23. The mould according to any one of claims 20 to 22 wherein the heating structure comprises an electrical conductor.

24. The mould according to any one of claims 20 to 22 wherein the heating structure comprises a conduit for a heated fluid.

25. Apparatus for rotating a mould during a process of rotational moulding comprising a cradle for mounting the mould wherein the cradle is adapted to be moved to thereby move the mould during rotational moulding, the cradle comprising a heating structure to be placed in contact with the mould when the mould is mounted in the cradle, said heating structure heating the mould when mounted in the cradle during rotational moulding.

26. The apparatus according to claim 25 wherein the mould is a pressure vessel.

27. The apparatus according to claim 25 or claim 26 wherein the heating structure comprises an electrical conductor.

28. The apparatus according to claim 25 or claim 26 wherein the heating structure comprises a conduit for a heated fluid.

29. The apparatus according to any one of claims 25 to 28, comprising a base to which a supporting arm is connected, the supporting arm supporting the cradle.

30. The apparatus according to claim 29, wherein the supporting arm pivots relative to the base and the extent of the pivot is controlled by a hydraulic piston.

31. The apparatus according to claim 29 or 30, wherein at the end of the supporting arm, distal to the base, a rotating cage is connected.

32. The apparatus of claim 31, wherein an inner surface of the cage is provided with the cradle.
